(19) United States
(12) Patent Application Publication
(10) Pub. No.: US 2024/0321473 A1
(43) Pub. Date: Sep. 26, 2024

(54) System and Method of Producing Radioisotopes Using Multiple Target Chambers and Multiple Beam Lines at Variable Energy Levels

(71) Applicant: JB RADIOPHARMACEUTICALS HOLDINGS CORP., Las Vegas, NV (US)

(72) Inventors: Lin Shao, College Station, TX (US); Alan Kempner Davis, Berkeley, CA (US)

(21) Appl. No.: 18/613,090

(22) Filed: Mar. 21, 2024

Related U.S. Application Data
(60) Provisional application No. 63/453,562, filed on Mar. 21, 2023.

(51) Int. Cl. G21G 1/10; H05H 7/08; H05H 7/12; H05H 9/04

(52) U.S. Cl. CPC G21G 1/10; H05H 7/12; H05H 9/042; H05H 2007/082; H05H 2007/122

(57) ABSTRACT

An accelerator system and/or method is used to create radionuclides through particle bombardments of target elements by generating a collimated and focused energetic particle beam. The accelerator system and/or method is provided with an ion source, a main beam transport pipeline, a plurality of acceleration tanks, a plurality of beam tuning devices, a plurality of target transport pipelines, a plurality of magnet kickers, and a plurality of target chambers.

The current application claims a priority to the U.S. provisional patent application Ser. No. 63/453,562 filed on Mar. 21, 2023.

### FIELD OF THE INVENTION

The present invention generally relates to radioisotope production using ion accelerators. More specifically, the present invention relates to a method to maximize the yields and varieties of radioisotopes produced by using drift-tube linear accelerators.

### BACKGROUND OF THE INVENTION

Electron, proton, deuterium, alpha, and neutron irradiation of specific nuclides can induce nuclear reactions and transmutation of these nuclides into radionuclides. Such transmutation has found a wide range of applications in radiation therapy, nuclear imagining, and nuclear medicine. Cyclotron accelerators, linear accelerators, and reactors are three major instrumental types in producing medically important radiopharmaceuticals.

Linear accelerators generate high-frequency alternating electric fields around the line of hollow “drift” tubes. The tube lengths and the frequency are selected in a way that particles exiting one tube are always accelerated through the gap towards the next tube. A linear accelerator is able to obtain very high beam energies with relatively low cost and easiness in device manufacturing, routine operation, accelerator maintenance, and post-transmutation processing.

The main disadvantage of linear accelerators is the lack of flexibility in changing accelerated ion species and beam energies. Linear accelerators have pre-determined ion species and beam energies since tube dimensions, and tube arrays are characteristics of specific ion-energy selections. The flexibility of beam energy changes brings flexibility to radionuclide production. The yields of specific radionuclides are beam energy dependent. Threshold energies exist in all proton-induced transmutations, and the energy varies for different isotopes.

A method for radioisotope production using multiple energy sources is described in U.S. Pat. No. 6,444,990 to I. L. Morgan, et al., entitled “Multiple Target, Multiple Energy Radioisotope Production”. According to the '990 patent, a plurality of linear accelerators are used to accelerate particles with an accelerator outlet of one linear accelerator connected to an accelerator inlet of the next linear accelerator to create a sequential array, and each individual accelerator in the array can be pulsed on and off to vary the particle beam energy. The method has the issue of losing beam transport control when one or a few accelerators are turned off. Since linear accelerators are connected directly to each other, there is no beam-focusing device installed between any neighboring accelerators. When one linear accelerator is turned off, beam expansion occurs in the accelerator, causing beam defocusing and beam scattering. Consequently, beam quality drops significantly, and the system control is unstable when charging and sparking occur for a poorly transporting beam.

The same '990 patent describes a method to use kicker magnets to pass pulsed beams into different target paths. The method, however, is unrealistic since kicker magnets operated under a pulsing mode have difficulties passing the beam to the same target paths even if the electric currents driving the kicker magnets are the same. The Kicker magnet requires feedback mechanisms to adjust the effects from beam energy fluctuation and beam position shifting accumulated upstream of the kicker magnet. When the pulsed beam is operated under a high frequency, manual adjustment of the kicker magnet is impossible. The '990 patent does not describe a method that allows self-adjustments of the kicker magnets under high-frequency switching.

Another method for obtaining beams of variable energies using linear accelerators is described in U.S. Pat. No. 4,485,346 to D. A. Swenson et al., entitled “Variable-energy Drift-tube Linear Accelerator”. The method is to change the positions of the post-coupler, which disturbs the electric fields around the gap in a linear accelerator. The method, however, is limited to the later portion of drift tubes and has a limited adjustable range.

Another well-known method in the field is to use a thin foil to reduce the beam energy through the electronic stopping of beams in the foil. The ion-foil interactions cause significant beam energy contamination, ion scattering, and ion charge neutralization. This makes the subsequent beam focusing and bending more difficult to carry out, which affects beam quality control. Since high beam energy outputs consumes more power to achieve, the method of acceleration plus deceleration is not ideal for cost-saving.

Therefore, an objective of the present invention is to provide a method to have integrated system control of linear accelerators, which allows radionuclide productions of different kinds, using variable beam energies and improved beam quality.

Another objective of the present invention is to provide a method to maximize the yields of radionuclide production of different kinds through simultaneous beam irradiation of multiple target chambers. These chambers can be either located along the same beam line or located at different beamlines.

### SUMMARY OF THE INVENTION

In accordance with one exemplary embodiment, an accelerator system of integrated control for simultaneous isotope production in multiple chambers is disclosed. The beam can be steered into different beamlines through a plurality of post-acceleration magnets. Each beamline includes a feedback device that provides information for automatic self-adjustment of bending magnets, avoiding beam misalignment under high-frequency magnet on-and-off switching.

In accordance with another exemplary embodiment, simultaneous isotope production in multiple chambers of one beamline is disclosed. The target system includes a stack of two target chambers, with the first chamber creating gas radionuclides using a beam at relatively high energies and the second chamber creating solid radionuclides using a beam at relatively low energies.

In accordance with another exemplary embodiment, an accelerator system containing multiple independent-controlled acceleration tanks and multiple beam-focusing components for energy-variable isotope production is disclosed. Beam focusing/steering components are positioned between each acceleration tank, allowing beam tuning to compensate for the space charge effect when individual acceleration tank(s) is not energized.

In accordance with another exemplary embodiment, an accelerator system containing independent-controlled drift tubes and beam-focusing components within each drift tube is disclosed. Drift tubes can be optionally de-energized, and beam-focusing components within each drift tube can be independently energized and adjusted to guarantee high-quality beam transport.

In accordance with another exemplary embodiment, an accelerator system containing independent-controlled drift tubes and beam-focusing components between a plurality of neighboring drift tubes is disclosed. Drift tubes can be optionally de-energized, and beam-focusing components between drift tubes can be independently energized and adjusted to guarantee high-quality beam transport.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 depicts a linear accelerator system containing multiple target beam lines and multiple target chambers.

FIG. 2 depicts a beam feedback system allowing automatic adjustment of bending magnets.

FIG. 3 depicts an integrated control of the system component.

FIG. 4 depicts a two-chamber configuration in which a gas chamber is positioned immediately before a liquid target chamber.

FIG. 5 depicts a two-chamber configuration in which a gas chamber is positioned immediately before a liquid target chamber, and the liquid target chamber allows evaporation and condensation of liquids upon irradiation.

FIG. 6 depicts a two-chamber configuration in which a gas chamber is positioned immediately before a solid target chamber.

FIG. 7 depicts multiple acceleration tanks and the insertion of beam-tuning devices between two neighboring tanks.

FIG. 8 depicts a drift-tube accelerator tank in which each drift tube contains quadruples for beam focusing.

FIG. 9 depicts a drift-tube accelerator tank in which an independent beam-focusing device is added between a plurality of drift tubes.

### DETAILED DESCRIPTION OF THE INVENTION

All illustrations of the drawings are for the purpose of describing selected versions of the present invention and are not intended to limit the scope of the present invention.

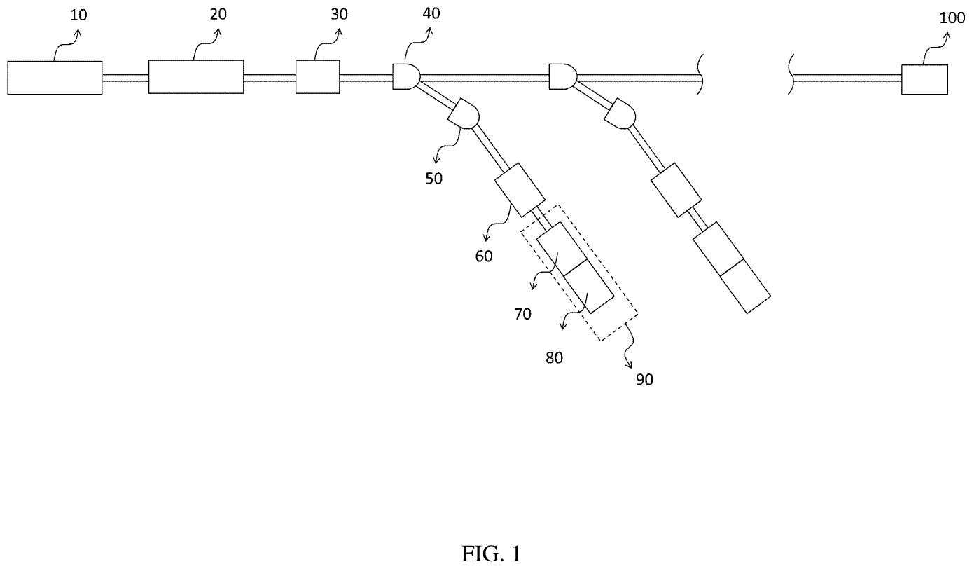

FIG. 1 depicts an exemplary embodiment of an accelerator system for isotope production in multiple target chambers. A charged ion beam (i.e., proton in this particular embodiment) is created from an ion source 10. The ion source typically contains the component creating plasma, extracting ions of predetermined charges (i.e., either positive or negative) from the plasma chamber, acceleration to a predetermined energy, beam focusing, and beam purification through a magnet. The beam from ion source 10 is injected into acceleration complex 20. The acceleration complex 20 can be a single acceleration tank or a plurality of tanks of different kinds. In one embodiment, acceleration complex 20 consists of one RFQ and several drift-tube accelerator tanks. In another embodiment, complex 20 consists of multiple drift-tube tanks. Ions are accelerated to a predetermined energy after exiting tank 20. Ions are then tuned through beam tuning component 30 for beam focusing and shape modulation. The tuning device 30 can be pairs of electrostatic deflectors that create an electric field along the horizontal direction and vertical direction (i.e., viewed by beam) to change beam spot position or pairs of magnets in the configuration known as quadrupoles to change beam spot size through defocusing and focusing or a combination of both electrostatic deflector and quadrupoles. The tuned and focused beam is then directed through a magnet kicker 40. If the kicker is not energized, the beam will continue the straight-line path pointing towards terminating target 100. If energized to a predetermined value, the magnet kicker 40 deflects the beam towards a secondary magnet 50. Magnet 50 deflects the beam further toward the terminating target chamber 90. Prior to entering target chamber 90, the beam goes through a beam monitoring device 60. Device 60 provides feedback to the control system about the perfection of the beam alignment along the pipeline. The target chamber 90 can be a single chamber or multiple chambers. In the embodiment, chamber 90 includes chamber 70 and chamber 80. Since ions lose energy and stop upon interactions with air molecules, the whole accelerator system is required to keep at vacuum better than 1×10−4 torr, except for the ion source 10 where the local vacuum can be poorer. Vacuum pumps and vacuum reading devices are not shown in FIG. 1.

The magnet kicker 40 often requires very fast rise and/or fall time (i.e., typically 50 nanoseconds to 1 microsecond). The charged particles are deflected under either a magnetic field or an electric field. In general, kicker systems use magnetic fields to deflect high energy beams since the deflection by an electric field is less efficient. A magnet kicker often uses coaxial cables as transmission/control lines in order to transmit fast pulses and high current. Kicker magnets generally need to be fast, leading to a single turn coil. A multi-turn coil is often used for slow kicker magnets. Kicker magnets can have either closed C-core or open C-core designs and can be installed in or externally to vacuum. A superfast magnet kicker is often powered by thyratron switches.

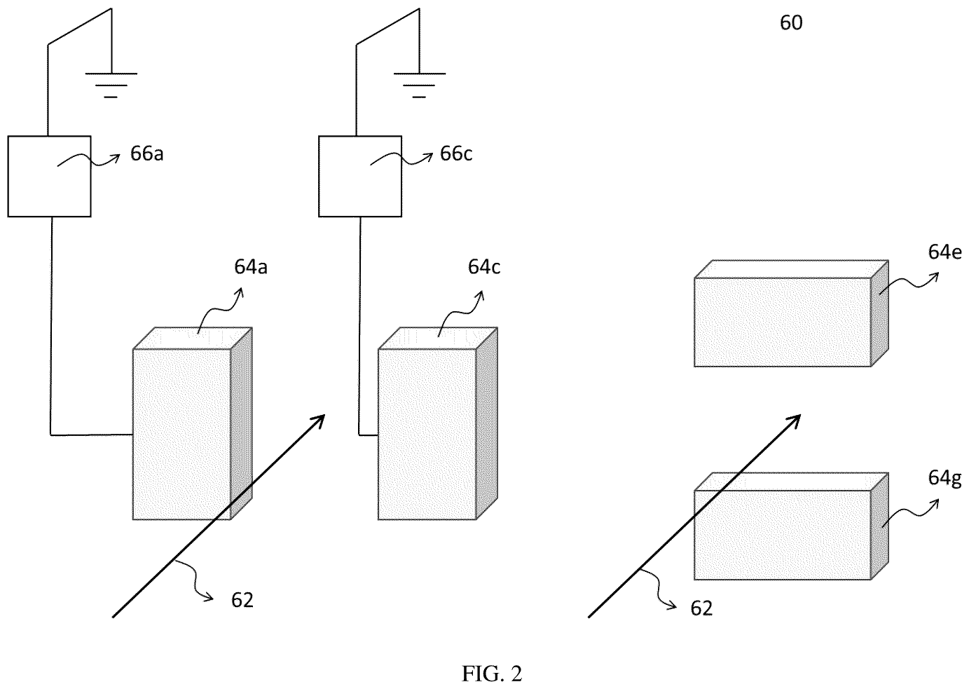

FIG. 2 depicts one typical beam monitoring device 60, which contains a pair of charge collectors 64a, 64c, oriented horizontally and a pair of charge collectors 64c, 64g, oriented vertically. The incident beam 62 passes through the open space between the charge collectors. Each charge collector is linked to a current meter. Charge collector 64a is linked to current meter 66a, and the charge collector 64c is linked to current meter 66c. If the beam falls into the horizontal middle of the open space, the amount of charge collected from collector 64a equals that collected from collector 64c. If beam 62 is off the center and is closer to 64a than 64c, the current reading from 66a becomes larger than that from 66c. Therefore, the imbalance of signals from 66a and 66c is used as feedback to adjust the magnet kicker to re-position beam 62 into the center of the open space. In a similar way, vertically positioned charge collectors 64e and 64g can be used to collect beam-induced charge signals and provide feedback to the beam defector to re-position the beam along the vertical direction. The beam deflector for the vertical position adjustment can be added in the beam line after the magnet kicker or added as one device belonging to acceleration complex 20 (i.e., as shown in FIG. 1). Secondary electron emission plays a significant role in influencing charge collection. For a negatively charged ion beam, a large number of secondary electrons may be produced upon the beam bombardments over a charge collector, inducing a strong positive charge signal in the corresponding current meter. The positive charges still represent the intensity of the beam bombarded and can be used as feedback signals. Alternatively, the charge collectors can be biased positively through their connections to batteries. The bias can trap secondary electrons and remove/reduce the artifacts.

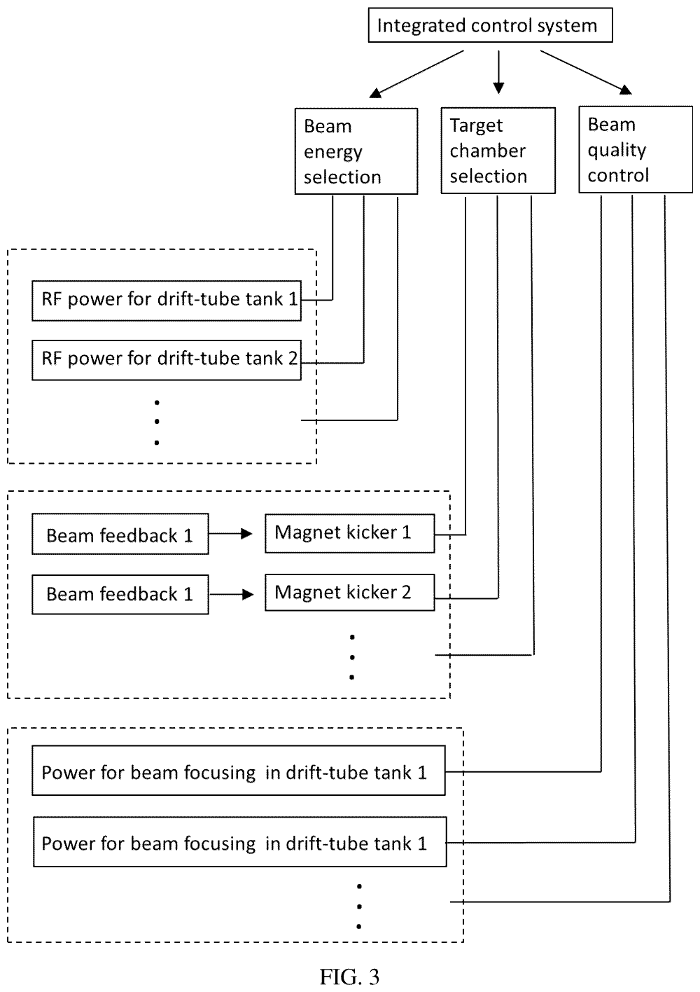

FIG. 3 is a block diagram of the system control as one exemplary embodiment. The integrated control system allows flexibility in beam energy selections (i.e., at discrete levels) and target chamber selection. For the embodiment, which uses a plurality of drift-tube accelerator tanks in a sequential arrangement, the radio frequency power of each drift-tube tank is independently energized. The acceleration reaches the maximum beam energy if all tanks are energized. If the latter portion of the tanks is de-energized, the final beam energy after exiting complex 20 (i.e., as shown in FIG. 1) is reduced. The selection of the target chambers is controlled by magnet kickers. Each magnet kicker can be switched on or off. The magnetic field is adjustable by changing the current passing through the coils creating the magnetic field. The correct current under switched-on condition is determined by the beam energy after exiting the last tank of complex 20 (i.e., as shown in FIG. 1). The magnet kickers are programmed to have the options of (1) beam entering into a specific target chamber only and (2) beam entering multiple target chambers, with irradiation time at each target chamber controlled by the magnet kicker systems. The beam monitoring devices provide feedback to adjust the current inputs for each magnet kicker. Such adjustment is needed considering the fluctuation of beam-system conditions under daily operation. The factors causing fluctuation include beam position shifting, beam heating, beam line misalignment, ion source instability, and magnet degradation.

The control system monitors and guarantees the beam quality. In one embodiment, beam-focusing systems are inserted between neighboring accelerator tanks. In another embodiment, beam-focusing components are within each drift tube. In another embodiment, beam-focusing components are inserted between a plurality of drift tubes. In all these embodiments, the control of beam-focusing devices is independent: the control does not rely on whether drift tubes are energized or not. In operation requiring reduced beam energy, beam focusing systems are still operating while the latter portion of drift-tubes is de-energized (i.e., in the off mode). The focusing minimizes the beam expansion and the space charge effect.

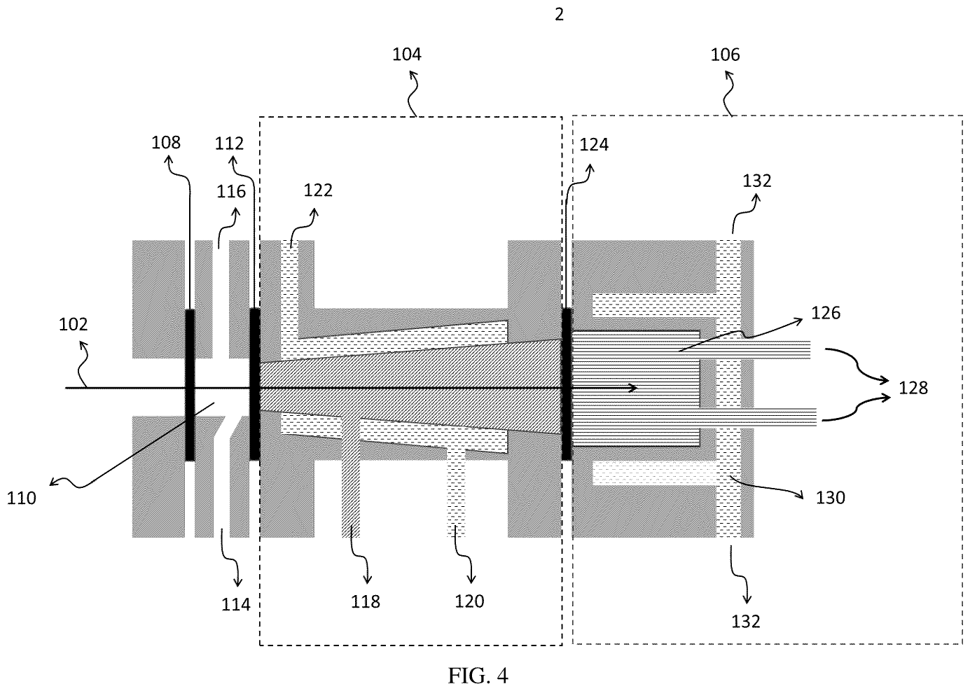

FIG. 4 explains one exemplary embodiment of target system 2 containing two target chambers stacked. The gas target chamber 104 is positioned immediately before the liquid target chamber 106. The beam 102 is able to penetrate through the first chamber 104, producing radionuclides through beam interaction with element 118 (i.e., in a gas phase), and reach the second chamber 106, producing radionuclides through beam interaction with element 126 (i.e., in a liquid phase). The system further contains a foil 108 which separates the vacuum source from the target chamber. The beam 102 penetrates through foil 108, and then penetrates through a second foil 112. The second foil 112 forms part of the wall of the gas chamber 104. Between foils 108 and 112 there is an open space 110, allowing cooling gas such as helium injected through the entrance 114 to cool the second foil 112. The injected cooling gas exits from port 116. The gas target chamber 104 is filled with element 118 at a pressure/density which is insufficient to stop the beam, allowing beam penetration through the chamber wall 124 and enter into the second chamber 106. Liquid medium 126 enters and exits chamber 106 through 128. Chamber 106 is cooled by coolant 128. Coolant 130 enters and exits through channels 130. Coolant 130 can be either gas or water.

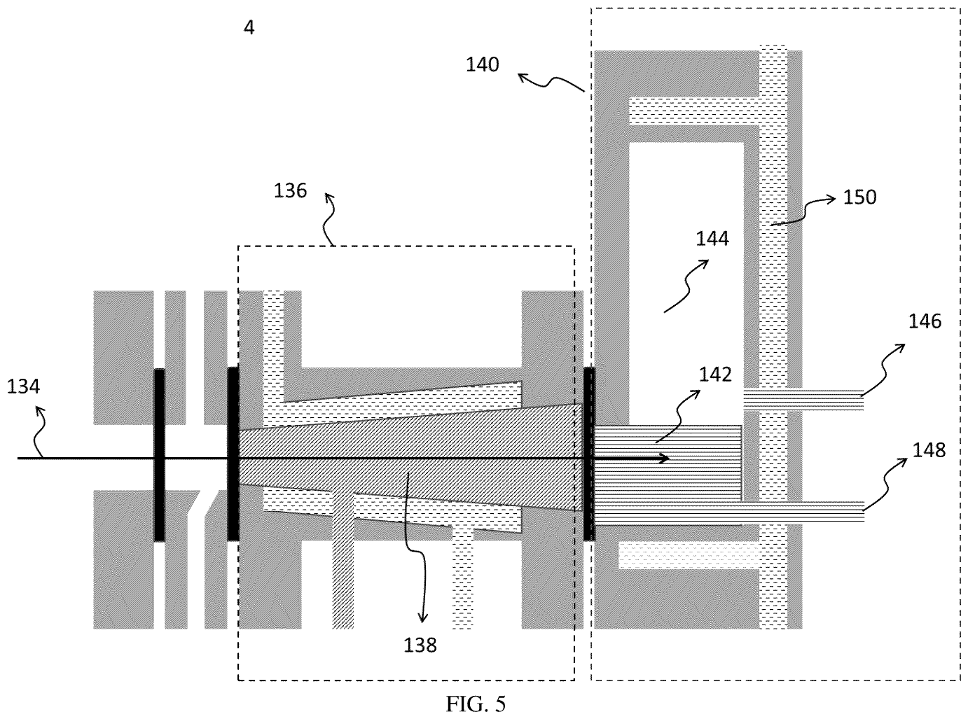

FIG. 5 explains another exemplary embodiment of target system 4, containing two target chambers stacked gas chamber 136 and liquid chamber 140. Gas chamber 136, containing gas medium 138, is positioned immediately before liquid chamber 140 containing liquid medium 142. Beam 134 is energetic enough to interact with medium 138 in the gas chamber 136, penetrating through the chamber wall between chambers 136 and 140 and entering the liquid chamber 140. Chamber 140 further contains a large volume 144 on top of liquid medium 142. The walls of volume 144 have a large surface area, allowing evaporated atoms from liquid 142 to be condensed and flow back to the bottom portion of chamber 140. Liquid medium 142 enters through entrance 146 and exits from port 148. Coolant 150 is provided to reduce the heat and facilitate the condensation of vaporized atoms from liquid 142 on the walls 144.

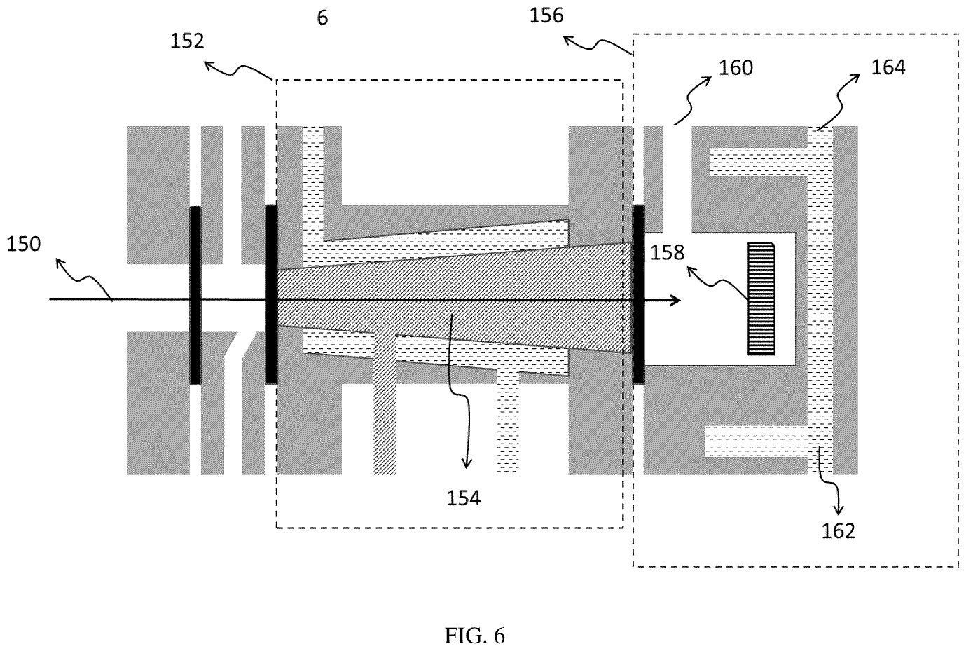

FIG. 6 depicts another exemplary embodiment of target system 6, comprising two target chambers 152 and 156. Gas target chamber 152 is positioned immediately before solid target chamber 156. Beam 150 is able to penetrate into gas target chamber 152 and to interact with gas medium 154 and continues to penetrate into solid target chamber 156 and to interact with solid target 158. Chamber 156 contains an open volume in which element 158 is positioned inside. The open volume has an exit 160, which allows air molecules to be pumped out of the open volume. Chamber 156 includes cooling channel 164, which allows coolant 162 diffuse in and out of the chamber to reduce temperatures of chamber 156 and target 158.

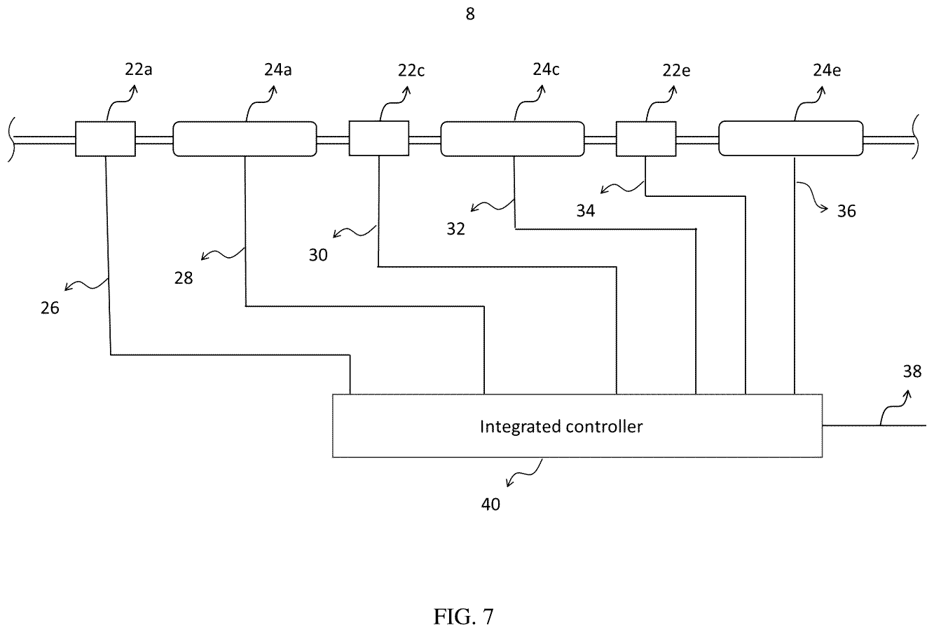

FIG. 7 shows one example of integrated device control over acceleration complex 8 comprising multiple acceleration tanks 224a, 224c, and 224c, and multiple beam tuning devices 222a, 222c, and 222e interposed between the acceleration tanks. The acceleration tanks change beam energies, and the beam tuning devices do not change beam energies but change beam spot size and shape. The beam transports from the left and enters into the first beam tuning device 222a for beam focusing, then enters the first acceleration tank 224a to increase beam energy, and then enters the second beam tuning device 222c for additional beam focusing. The beam acceleration continues through passing tanks 224c and 224e, and beam focusing continues through passing device 222c. The alternatively positioned beam acceleration tanks and beam-focusing devices can be further added with numbers beyond the example shown in FIG. 7. The control lines 226, 228, 230, 232, 234, and 236 link the corresponding acceleration tank or beam focusing device to an integrated controller 240. Controller 240 further has control lines 238 which are linked to magnet kickers, target stations, valves, and other systems outside of the acceleration complex 8.

Controller 240 can individually control each device/tank/component. The controller 240 can optionally energize, de-energize, partially energize, switch on, switch off, run continuously, or run in a pulsed model for each device/tank/component. The control can be programmed such that beam focusing and beam acceleration can select a specific device/tank or a group of devices/tanks, while other devices/tanks can be intentionally de-energized/switched off. In one example, beam focusing device 222a and acceleration tank 224a are energized (i.e., or switched on), while 222c, 222e, 224c, and 224e are de-energized (i.e., or switched off). In another example, 222a, 224a, 222c, and 224c are energized, while 222e and 224e are de-energized. The selection of the device/tank/component allows the beam energy to be adjustable. In one example, 224a is energized while 224c and 224e are de-energized, allowing the final beam energy to reach relatively low energy. In another example, 224a, 224c, and 224e are energized, allowing the final beam energy to reach relatively high energy.

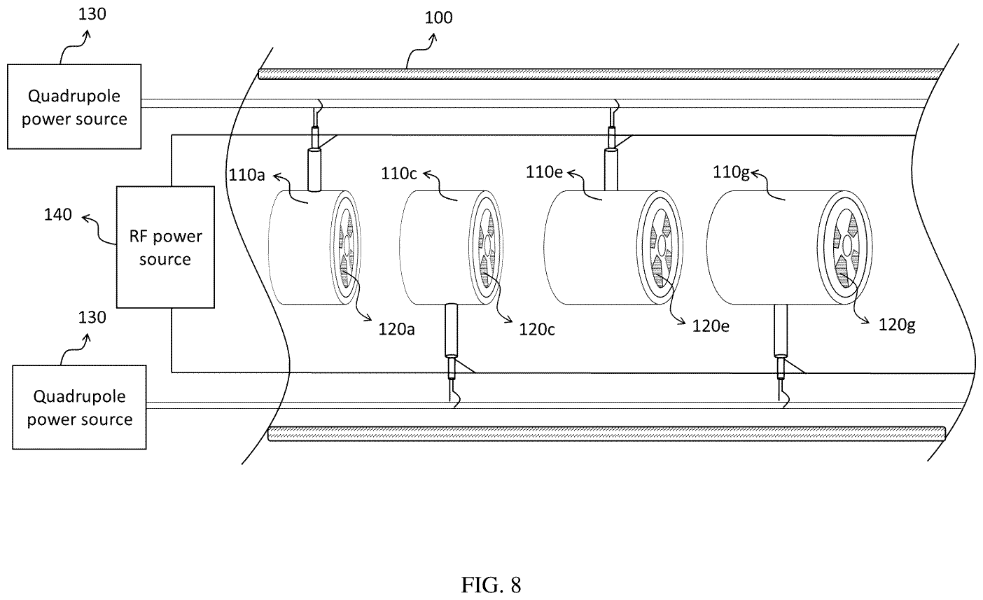

FIG. 8 shows one example of a drift-tube accelerator tank 300 containing independent control of acceleration and beam focusing. The tubes 310a, 310c, 310c, and 310g are powered by an external radio-frequency (RF) power source 340. The tube lengths are gradually increased to compensate for the changes caused by velocity gain. Therefore, the amount of flying time inside each tube is approximately the same. The electric field at the gap of the neighboring tubes accelerates the beam, and RF power selects a frequency that guarantees the electric field directions are the same when particles exit from each tube. Inside each tube, there are quadrupole magnets used to focus the beam and minimize the beam dispersion upon transporting. The quadruple magnets 320a, 320c, 320c, and 320g are contained inside tubes 310a, 310c, 310e, and 310g, respectively. The quadruple magnets 320a, 320c, 320e, and 320g are powered externally by quadrupole power source 330. The RF power source 340 and the quadrupole power source 1330 are separately controlled. It is an option to de-energize tubes (i.e., the RF power source 340 is powered off) but energizes quadrupole magnets (i.e., the quadrupole power source 330 is powered on). Such a design allows the beam to keep the same energy when passing through the de-energized drift-tube accelerator tank while the beam shape and beam diameter are still controlled through the operation of quadrupole magnets.

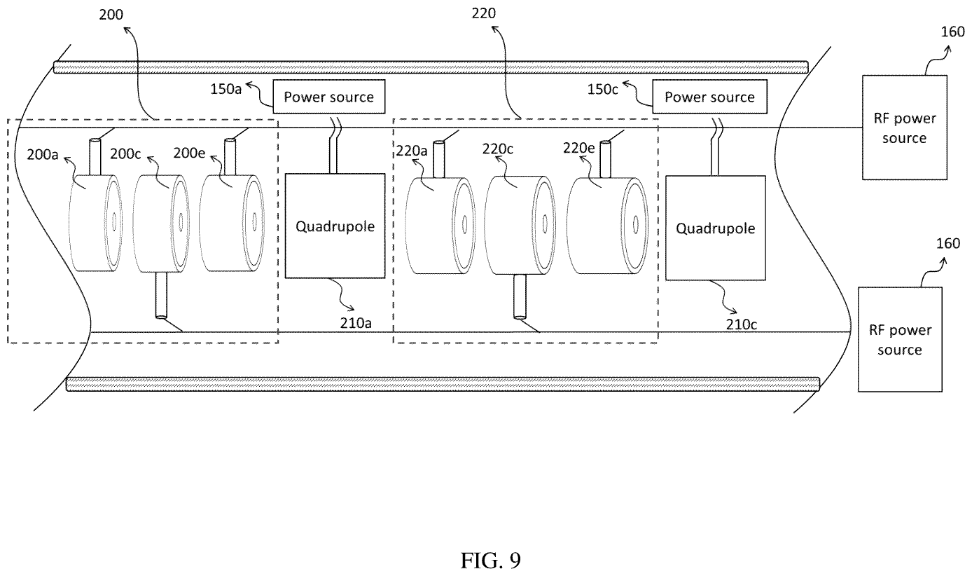

FIG. 9 shows another example of a drift-tube accelerator tank containing independent control of acceleration and beam focusing. The tubes 400a, 400c, 400c, 420a, 420c, and 420e are used to accelerate the beam to higher beam energies. The tubes 400a, 400c, and 400e belong to one tube group 2400. The tubes 420a, 420c, and 420e belong to another tube group 420. Between the neighboring tube groups 400 and 420, there are quadrupole magnets 410a. Between tube group 2420 and the next tube group (i.e., not shown), there is another quadrupole magnet assembly 410c. The quadrupole magnet 410a is powered by the power source 450a. The quadrupole magnet 410c is powered by the power source 450c. The power source 450a and the power source 450c can be separate power sources or the same power source through sharing. Tube group 400 and tube group 420 are powered by power source 460. Optionally tube group 400 and tube group 420 can be powered independently, allowing one group to be turned on and the other group to be turned off.

The foregoing description of the invention has been presented for purposes of illustration and description and is not intended to be exhaustive or to limit the invention to the precise form disclosed, and obviously, many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. For example, the feedback system positioned after a kicker magnet for repeatable and high-accuracy beam transport to a specific target path can be applied to a cyclotron accelerator for the purpose of isotope production. A similar multiple target chamber configuration or dual chamber configuration for multiple isotope production at the same time can be applied to a cyclotron accelerator for the purpose of isotope production. Although the invention is for radioisotope production, the beam feedback and system control concepts can be applied to general ion-solid interaction applications for which the purpose may not be isotope production. Examples of available applications include, but are not limited to, ion implantation for device doping, ion beam analysis, ion modification of materials, and ion bombardment testing of devices.

Although the invention has been explained in relation to its preferred embodiment, it is to be understood that many other possible modifications and variations can be made without departing from the spirit and scope of the invention as hereinafter claimed.

What is claimed is:

1. An accelerator system for creating radionuclides through particle bombardments of target elements by generating a collimated and focused energetic particle beam, the accelerator system comprising:
an ion source creating a beam at relatively low energy and injecting the beam into a main beamline of a main beam transport pipeline;
a plurality of acceleration tanks and a plurality of beam tuning devices on the main beam transport pipeline, wherein each accelerating tank contains a plurality of drift tubes, and wherein the drift tubes are powered by radiofrequency power sources, and wherein a first acceleration tank from the plurality of acceleration tanks accelerates the beam to a first energy, and wherein a second acceleration tank from the plurality of acceleration tanks accelerates the beam to a second energy, and wherein the beam tuning devices are configured to deflect beams, wherein the beam tuning devices are further configured to focus, de-focus, change a beam spot size, and wherein the beam tuning devices are further configured to change beam shapes;
a plurality of target transport pipelines and a plurality of magnet kickers, wherein the magnet kickers positioned on the main beamline are configured to be individually controlled and individually switched on to deflect the beam to selected target transport pipelines from the plurality of target transport pipelines, and wherein each magnet kicker is configured to be switched on at a selected time and powered on for a selected time period; and
a plurality of target chambers, wherein each target transport pipeline is terminated by a corresponding target chamber from the plurality of target chambers, and wherein at least one target chamber from the plurality of target chambers is in a stacked configuration comprising a first chamber immediately positioned before a second chamber, and wherein the first chamber and the second chamber are from the plurality of target chambers, and wherein the first chamber is configured to hold gas target medium, and wherein the second chamber is configured to hold gas/liquid/solid target medium, and wherein the gas target medium in the first chamber is configured to interact with accelerated particles producing a first radionuclide, and wherein the gas/liquid/solid target target medium in the second chamber is configured to interact with accelerated particles producing a second radionuclide.

2. An accelerator system for creating radionuclides through particle bombardments of target elements by generating a collimated and focused energetic particle beam, the accelerator system comprising:
an ion source creating a beam at relatively low energy and injecting the beam into a main beamline of a main beam transport pipeline;
a plurality of acceleration tanks and a plurality of beam tuning devices on the main beam transport pipeline, wherein each accelerating tank contains a plurality of drift tubes, and wherein the drift tubes are powered by radiofrequency power sources, and wherein a first acceleration tank from the plurality of acceleration tanks accelerates the beam to a first energy, and wherein a second acceleration tank from the plurality of acceleration tanks accelerates the beam to a second energy, and wherein the beam tuning devices are configured to deflect beams, and wherein the beam tuning devices are further configured to focus, de-focus, change a beam spot size, and wherein the beam tuning devices are further configured to change beam shapes;
a plurality of target transport pipelines and a plurality of magnet kickers, wherein the magnet kickers positioned on the main beamline are configured to be individually controlled and switched on to deflect the beam to selected target transport pipelines from the plurality of target transport pipelines, and wherein each magnet kicker is configured to be switched on at a selected time and powered on for a selected time period;
a plurality of target chambers, wherein each target transport pipeline is terminated by a corresponding target chamber from the plurality of target chambers; and
an integrated control system, wherein the integrated control system is configured to individually control each acceleration tank, each beam tuning device, and each magnet kicker, and wherein the integrated control system is configured to switch on selected acceleration tanks from the plurality of acceleration tanks but switch off other acceleration tanks from the plurality of acceleration tanks.

3. The accelerator system of claim 2, wherein each target transport pipeline further comprises a beam feedback system, and wherein the beam feedback system provides signals to the integrated control system to adjust at least one beam tuning device to re-position the beam spot.

4. The accelerator system of claim 3, wherein the beam feedback system comprises a pair of charge collectors, wherein each charge collector is positioned in a horizontal orientation, and wherein an open space is positioned between the charge collectors, and wherein charge signals collected from the charge collectors are read through a current meter, and wherein a current reading from each charge collector is provided to the integrated control system.

5. The integrated control system of claim 2, wherein the selected acceleration tanks are switched on, and wherein the other acceleration tanks are switched off.

6. The accelerator system of claim 5, wherein the first acceleration tank is switched on, and wherein the second acceleration tank is switched off, and wherein a beam energy prior to entering any target chamber from the plurality of target chambers is equal to the first energy.

7. The accelerator system of claim 2, wherein the beam tuning devices are positioned before and after each accelerator tank, wherein powers of the beam tuning devices and the accelerator tanks are independently controlled, wherein the integrated control system is configured to switch off the other acceleration tanks but keep switched on the beam tuning devices.

8. The accelerator system of claim 2, wherein at least one acceleration tank from the plurality of acceleration tanks contains a plurality of independently-controlled drift tubes from the plurality of drift tubes and a plurality of quadruple magnets, and wherein corresponding quadruple magnets from the plurality of quadruple magnets are positioned between a plurality of neighboring drift tubes from the plurality of independently-controlled drift tubes, wherein selected drift tubes from the plurality of independently-controlled drift tubes are switched off by the integrated control system, and the corresponding quadruple magnets between the selected drift tubes are independently switched on.

9. The accelerator system of claim 2, wherein at least one acceleration tank from the plurality of acceleration tanks contains a plurality of independently-controlled drift tubes from the plurality of drift tubes and a plurality of quadruple magnets, and wherein each independently-controlled drift tube contains corresponding quadruple magnets from the plurality of quadruple magnets, and wherein selected drift tubes from the plurality of independently-controlled drift tubes are switched off by the integrated control system, and wherein the corresponding quadruple magnets within the selected drift tubes are independently switched on.
